(19) United States
(12) Patent Application Publication
(10) Pub. No.: US 2007/0293274 A1
(43) Pub. Date: Dec. 20, 2007

(54) Mobile telecommunications terminal

(76) Inventor: Arnold Gieseke, Giesen (DE)

Correspondence Address: KENYON & KENYON LLP, ONE BROADWAY, NEW YORK, NY, 10004, US

(21) Appl. No.: 11/893,720

(22) Filed: Aug. 16, 2007

Related U.S. Application Data
(63) Continuation of application No. 10/110,622, filed on Aug. 12, 2002, now abandoned.

(30) Foreign Application Priority Data
Oct. 15, 1999 (DE) 19949716.8

(51) Int. Cl. H04M 1/00

(52) U.S. Cl. 455/566

(57) ABSTRACT

A mobile telecommunications terminal facilitates clarity and convenient operation. The mobile telecommunications terminal includes an operator interface which has a display device. Operating functions of the mobile telecommunications terminal may be represented on the display device and may be selected for activation in an object-oriented fashion.

### CROSS-REFERENCE TO RELATED APPLICATION

This application is a Continuation Application of prior U.S. patent application Ser. No. 10/110,622 filed Aug. 12, 2002, which was a National Stage Application of PCT International Application of PCT/DE2000/03605 filed Oct. 13, 2000, which claimed priority to German Patent Application No DE 19949716.8 filed Oct. 15, 1999, all of which are incorporated herein by reference in their entirety.

### FIELD OF THE INVENTION

The present invention relates to mobile telecommunications terminals.

### BACKGROUND INFORMATION

Presently, mobile telecommunications terminals exist that include an operator interface having a display device.

### SUMMARY

The mobile telecommunications terminal according to the present invention may provide the advantage that the operating functions of the mobile telecommunications terminal may be represented in the display device and may be selected for activation in an object-oriented fashion. In this manner, a uniform operating platform is created for all operating functions, simplifying use for the user. In this context, the operating functions are represented on the display device as objects and may be selected and activated on the display device. The operating functions therefore do not have to be started by inputting preselected key combinations. The logical command routines necessary to activate the operating functions are transferred to a processing plane that is not visible to the user of the mobile telecommunications terminal. Knowledge of the logical and technical interrelations is no longer necessary to activate the operating functions because they are executed in the background. New and more complex services, such as multimedia services, are made more easily accessible for the user in this manner, because the user is no longer required to know the technical sequences of the assigned operating functions that are necessary to use the multimedia services, but rather these functions may start simply by selecting an assigned object on the display device.

A distinct, object-oriented representation of the operating functions on the display device is provided through the use of icons.

Incoming calls may be represented as icons on the display device and may be received by selecting the corresponding icon. In this manner, the location of the reproduction of an incoming call on the mobile telecommunications terminal and the location of its reception are identical, so that only a minimum of knowledge may be required from the user for operating the mobile telecommunications terminal, and the user need not necessarily have read the operating instructions to operate the telecommunications terminal. The cumbersome search for keys which may function to receive the incoming call is thus eliminated. In addition, a visual representation requires no linguistic knowledge from the user.

The icons may differ in accordance with the type of incoming call. In this manner, the type of incoming call may be represented particularly clearly on the display device. In addition, it is possible to represent a plurality of different incoming calls of different types at the same time on the display device and therefore to make it possible for the user to choose which of the incoming calls he would like to receive. By selecting and activating an icon of this type, the necessary operating function for receiving the call in question may be started automatically in order to make available, to reproduce, the information coming in along with the call.

Operating functions may be represented on the display device in a context-oriented fashion. In this manner, it is possible to save space on the display device by representing only the operating functions that may be necessary for the specific instantaneous operating state on the display device. Therefore, clarity for the user is further improved because no operating functions that are unnecessary for the instantaneous operating state are offered for selection and activation.

At least one selection function may be represented on the display device as an icon and may be activated when the corresponding icon is selected. In this manner, selecting and activating selection functions on the display device is possible in a particularly clear manner, and may require no linguistic knowledge from the user. Thus comfort of operation for the user is further increased.

The operating functions may be selected for activation using a mouse pointer. In this manner, a graphics facility is also provided for selecting and activating the operating functions, which presupposes no linguistic knowledge and only minimal operating knowledge from the user.

The display device may be configured as a touch-sensitive display device, in which a depicted operating function may be selected for activation by touching the object-oriented representation on the display device that is assigned to that operating function.

If the user has linguistic knowledge, a selection and activation of an object-oriented operating function represented on the display device through voice input may be provided since it allows for selection without contact and for activation of the operating function. Selection and activation by voice input is therefore well-suited for use in a motor-vehicle or for the disabled.

### BRIEF DESCRIPTION OF THE DRAWINGS

FIG. 1 illustrates a mobile telecommunications terminal according to an example embodiment of the present invention having a display device in a first operating state of the mobile telecommunications terminal.

FIG. 2 illustrates the display device in a second operating state of the mobile telecommunications terminal.

### DETAILED DESCRIPTION

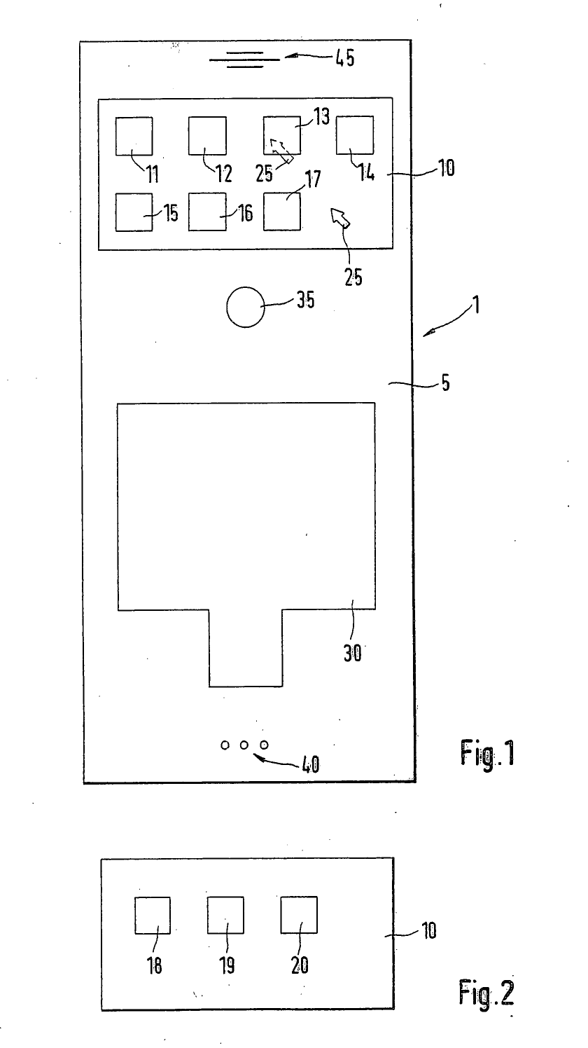

In FIG. 1, numeral 1 designates a mobile telecommunications terminal, which may be configured, for example, as a mobile telephone or cordless telephone. Mobile telecommunications terminal 1 includes an operator interface 5 having display device 10. Display device 10 may be configured as a liquid crystal display, for example. Additionally, operator interface 5 may optionally include an input unit that is configured as an alphanumeric keypad 30. Mobile telecommunications terminal 1 may include a receiver inset 45 having a speaker and a transmitter inset 40 having a microphone. In addition, operator interface 5 may include a track ball 35 between display device 10 and input unit 30, as is familiar in controlling a mouse pointer, for example, in a laptop.

On display device 10, operating functions of mobile telecommunications terminal 1 may be represented and may be selected for activation in an object-oriented manner. In this context, every operating function has assigned to it an icon, which is presented on display device 10. In this context, the individual object usually represents a sequence of software and/or hardware commands or applications, to be executed one after the other, which are necessary to realize the associated operating function. If an object of this type is selected and activated on display device 10, then the necessary commands of the associated operating function are automatically performed in sequence. For this purpose, the user does not have to input a cumbersome key combination, for example, to activate individual commands of the assigned operating function, and because of the simplicity of operation, it is also possible to omit consulting the operating instructions. The operating functions are therefore presented to the user particularly clearly for the purpose of selection and activation, so that time and effort in the operation of mobile telecommunications terminal 1 are saved.

This clarity may also be increased as a result of the fact that the object-oriented representation of the operating functions on display device 10 is performed using icons. Thus the user immediately recognizes the assigned operating function in the corresponding icon.

In the example embodiment described, display device 10 is configured so as to be context sensitive, i.e., only those operating functions are represented whose operation in the specific operating state of mobile telecommunications terminal 1 is possible. Thus space is saved on display device 10, and the user is spared the operation of operating functions that do not pertain to the instantaneous operating state. However, the use of a context-oriented, or context-sensitive, display device 10 is not obligatory for the functioning of the present invention. In FIG. 1, mobile telecommunications terminal 1 is represented in a first operating state, in which incoming calls are presented as icons on display device 10. In this context, by way of example, seven icons 11, 12, 13, 14, 15, 16, 17 are illustrated on display device 10, which stand for seven different types of incoming calls in a representative and not conclusive way. Thus a first icon 11 may stand, for example, for a conventional incoming voice call. A second icon 12 stands, for example, for an incoming call over the Internet. A third icon 13 stands, for example, for an incoming video call. A fourth icon 14 stands, for example, for an incoming fax call. A fifth icon 15 stands, for example, for an incoming electronic postal message, for example, in the form of an email. A sixth icon 16 stands, for example, for an incoming short message, for example, in accordance with the Short Message Service (SMS) System. A seventh icon 17 stands, for example, for a data file coming in over a telecommunications network. In this context, all the aforementioned incoming calls are transmitted over a telecommunications network, for example, a radio telecommunications network, to mobile telecommunications terminal 1. In the case of the electronic postal message or the incoming call over the Internet, Internet access of mobile telecommunications terminal 1 is provided via the radio telecommunications network, or access to a computer network is provided via the radio telecommunications network in the event of the transmission of data files. If a corresponding call arrives at mobile telecommunications terminal 1 via the radio telecommunications network, then the icon corresponding to the type of incoming call is displayed on display device 10, the icons differing one from the other in accordance with the type of incoming call. In this manner, an incoming conventional voice call may be illustrated as an icon using a stylized telephone. At incoming fax call may be depicted as an icon using a stylized fax machine. Thus, for every type of incoming call, an assigned icon may be found, which makes it possible to associate the incoming call to one of the aforementioned types. This represents for the user a particularly clear and distinct way to quickly recognize not only an incoming call, but also its type. In this context, the operating functions associated with icons 11, 12, . . . , 17 function to receive the incoming call represented by the appropriate icon. To receive an incoming call, the associated icon may now be selected. This may occur, for example, by a mouse pointer 25, illustrated on display device 10, being moved around display device 10 using track ball 35, until it reaches the desired icon. According to the example embodiment illustrated in FIG. 1, mouse pointer 25 has been moved to third icon 13, as the dotted line depiction illustrates. The activation of the operating function assigned to the selected icon may occur, for example, by pressing track ball 35 or by activating an input key on input unit 30.

It is also possible, in addition to or instead of track ball 35, to provide so-called cursor keys on input unit 30, by the activation of which mouse pointer 25 may be moved over display device 10 horizontally or vertically.

An additional arrangement for selecting and activating operating functions on display device 10 without using an additional operating element, such as a track ball or the keys of an input unit, may be realized by making display device 10 touch-sensitive. Then the selection of the desired operating function is performed by touching the corresponding icon. To activate the associated operating function, a further, or repeated, touching of the same icon may be provided. Selection and activation of an operating function may also occur by a single touching of the associated icon, namely by touching it for a preestablished minimum time.

The selection and activation of operating functions via a touch-sensitive display device 10 may additionally, or alternatively, be performed using mouse pointer 25.

Additionally or alternatively, a third possibility for selecting and activating operating functions may be provided using voice input. This is performed via transmitter inset 40 having the embedded microphone. In this context, the voice input for the selection and activation of an operating function, in association with an assigned icon, may occur, for example, as follows:

If an incoming fax call is to be received, then the selection is performed through the voice input of the word “fax.” The activation of the operating function, i.e., of the reception of the incoming fax call, then occurs through the subsequent voice input of the word “start.”

In FIG. 2, display device 10 is illustrated in a second operating state of mobile telecommunications terminal 1. In the second operating state, the context-oriented configuration of display device 10 makes possible a representation of the operating functions of mobile telecommunications terminal 1 using icons 18, 19, 20, which are different from icons 11, 12, 13, 14, 15, 16, 17, illustrated on the display device, and from the assigned operating functions. In this context, the second operating state of mobile telecommunications terminal 1 is achieved, in this example, from the first operating state, if, in the first operating state, second icon 12 was selected and activated, in order to receive an incoming fax call. In the second operating state, a selection function is offered to the user on display device 10 using an eighth icon 18, through the selection and activation of which the incoming fax call is represented in text form on display device 10, for which purpose the display device has previously been switched to a further third operating state for text reproduction of incoming calls. For this purpose, in this operating function, an application is executed, for example, automatically, which loads the received fax from a network provider into mobile telecommunications terminal 1, if the fax was stored by the network provider, for example, due to the previous non-availability of the user of mobile telecommunications terminal 1. Subsequently, an application is executed which automatically brings about a reproduction of the loaded fax, for example, in a bitmap format (BMP). Subsequently, a text recognition application is automatically executed, which recognizes texts in the fax call represented in accordance with the BMP format and which converts them, for example, into ASCII text characters, so that a text processing of the received fax is possible. The described processes with respect to the successive execution of applications for the received fax call are automatically started and performed in response to the selection and activation of eighth icon 18, so that the described object-oriented processing results. The user of mobile telecommunications terminal 1 therefore may not trouble himself to load the received fax from the network provider into mobile telecommunications terminal 1 and to effect a conversion into ASCII text characters. These processes are all initiated automatically when the user selects and activates eighth icon 18.

By selecting and activating a ninth icon 19 on display device 10, the user in the second operating state may activate a further selection function, in accordance with which the incoming fax call is reproduced in voice form. In this context, a necessary conversion from the text of the incoming fax call into speech is performed in accordance with the capacity of mobile telecommunications terminal 1 either at a network provider or in mobile telecommunications terminal 1 itself. In the case of a visual representation of the incoming fax call in text form, a format conversion may be used to adjust the representation to the characteristics of mobile telecommunications terminal 1. This adjustment may also be undertaken by the network provider or by mobile telecommunications terminal 1, depending on the capacity of mobile telecommunications terminal 1. The same and similar operating function sequences may be provided by selecting and activating the corresponding icon for all possible information contents that are transmitted by incoming calls, such as video calls, electronic postal messages, short messages, data files, etc.

Using a tenth icon 20, the user in the second operating state may select and activate a further selection function on display device 10, whereupon the reception of the incoming fax call is interrupted and the first operating state is recalled.

Each icon 18, 19, and 20 illustrated in the second operating state on display device 10, may also, through the appropriate representation, designate the selection function that is individually linked with it, so that the user, in viewing corresponding icons 18, 19, 20, immediately recognizes the appropriate selection function.

However, the object-oriented representation of operating functions on display device 10 of mobile telecommunications terminal 1 is not limited only to icons, but rather may also be realized through text symbols, although this presupposes the appropriate linguistic knowledge on the part of the user. A text symbol of this type in the first operating state may be constituted, for example, by the text “fax” for designating the operating function for the reception of an incoming fax call. In the second operating state, it is possible to represent, for example, the selection function for reproducing the incoming fax call in text form using the text symbol “text” on display device 10.

In this context, the selection and activation of the icon or text symbol in the second operating state is performed in the manner described for the first operating state.

It is also possible to provide both icons as well as text symbols on display device 10 for selecting and activating operating functions.

For the user, all operating functions are represented on display device 10 in the form of an icon, a text symbol, or generally as an object. These objects may be selected and activated using the methods described and, if appropriate, others, e.g., mouse pointer, touch-sensitive display device, voice input, etc. The fundamental difference with respect to existing operating mobile telecommunications terminals is that each operating function is represented in a uniformly abstract manner, and the technically oriented sequences that are necessary for the activation require no actions on the part of the user. In this context, all operating functions that may be activated by the user may be represented in a context-oriented fashion, and, if possible, they may be represented graphically in the form of icons, so as to produce an overall operating scheme. The benefits of an operating scheme of this type in accordance with the mobile telecommunications terminal of the present invention are particularly evident when, after the reception of a plurality of messages and/or calls, the mobile telecommunications terminal is switched on and, as a result of icons or text symbols on display device 10, information is provided regarding the number and type of calls received. In this context, it is also possible, when mobile telecommunications terminal 1 is switched on, to represent different incoming calls of the same type, e.g., different received fax calls, each by its own icon or text symbol on display device 10, so that the user may select which of the received fax calls he will access in which sequence. In this context, different incoming calls of the same type may be illustrated on display device 10 so as to be distinguishable from each other by numbering.

In addition, all the other possible operating functions of mobile telecommunications terminal 1, for example, pre-settings, e.g., for setting the volume of the speaker arranged in transmitter inset 45, may in the same manner be illustrated using objects, i.e., icons or text symbols, on display device 10 in a correspondingly addressable operating state of mobile telecommunications terminal 1 for selection and activation on display device 10 in the manner described. For this purpose, it may be possible in every operating state to provide, for example, an icon or text symbol for the selection and activation of a menu list on display device 10, the menu points in a further operating state of which may also be represented in the form of icons or text symbols on display device 10 for selection and activation.

When configured as a mobile telephone, mobile telecommunications terminal 1 may be configured, for example, in accordance with the GSM Standard (Global System for Mobile Indications) or in accordance with the UMTS Standard (Universal Mobile Telecommunications System). When configured as a cordless telephone, mobile telecommunications terminal 1 may be configured, for example, in accordance with the DECT Standard (Digital European Cordless Telecommunications).

1-10. (canceled)

11. A mobile telecommunications terminal, comprising:
an operator interface including a display device;
wherein the display device is configured to simultaneously represent a plurality of incoming calls on the display device as icons, to retrieve each incoming call in response to a selection of a corresponding icon, and to select for activation operating functions of the telecommunications terminal in an object-oriented manner, and
wherein there is a one-to-one correspondence between the icons and the incoming calls.

12. The mobile telecommunications terminal according to claim 11, wherein the display device is configured to represent each operating function in the form of an icon.

13. The mobile telecommunications terminal according to claim 11, wherein:
the display device is configured to represent each operating function in the form of an icon,
the icons are differentiated by a type of the incoming call, and
the display is configured to represent the operating functions in a context-oriented manner.

14. The mobile telecommunications terminal according to claim 11, wherein the icons are differentiated by a type of the incoming call.

15. The mobile telecommunications terminal according to claim 11, wherein the display is configured to represent the operating functions in a context-oriented manner.

16. The mobile telecommunications terminal according to claim 11, wherein the display is configured to represent at least one selection function as an icon, the selection function activatable in response to a selection of a corresponding icon.

17. The mobile telecommunications terminal according to claim 16, wherein the selection function corresponds to a selection of a type of reception of an incoming call.

18. The mobile telecommunications terminal according to claim 11, further comprising a mouse pointer configured to select the operating function to activate the operating function.

19. The mobile telecommunications terminal according to claim 11, wherein the display device is configured to operate in a touch-sensitive manner, an operating function represented on the display device selectable for activation in accordance with a touching of the corresponding object-oriented representation on the display device.

20. The mobile telecommunications terminal according to claim 11, wherein an operating function represented on the display device in an object-oriented manner is selectable for activation in accordance with a voice input.

21. The mobile telecommunications terminal according to claim 11, wherein the display device is configured to simultaneously represent the incoming calls on the display device as separate icons.

22. The mobile telecommunications terminal according to claim 11, wherein:
the display device is configured to represent each operating function in the form of an icon; and
the icons are differentiated by a type of the incoming call.

23. The mobile telecommunications terminal according to claim 11, further comprising a mouse pointer configured to select the operating function to activate the operating function, wherein:
the display is configured to represent at least one selection function as an icon, the selection function activatable in response to a selection of a corresponding icon; and
the selection function corresponds to a selection of a type of reception of an incoming call.

24. The mobile telecommunications terminal according to claim 23, wherein:
the display device is configured to represent each operating function in the form of an icon,
the icons are differentiated by a type of the incoming call, and
the display is configured to represent the operating functions in a context-oriented manner.

25. The mobile telecommunications terminal according to claim 23, wherein:
the display device is configured to operate in a touch-sensitive manner, an operating function represented on the display device selectable for activation in accordance with a touching of the corresponding object-oriented representation on the display device,
an operating function represented on the display device in an object-oriented manner is selectable for activation in accordance with a voice input, and
the display device is configured to simultaneously represent the incoming calls on the display device as separate icons.

26. The mobile telecommunications terminal according to claim 11, wherein:
the display device is configured to represent each operating function in the form of an icon,
the icons are differentiated by a type of the incoming call,
the display is configured to represent the operating functions in a context-oriented manner,
the display device is configured to operate in a touch-sensitive manner, an operating function represented on the display device selectable for activation in accordance with a touching of the corresponding object-oriented representation on the display device,
an operating function represented on the display device in an object-oriented manner is selectable for activation in accordance with a voice input, and
the display device is configured to simultaneously represent the incoming calls on the display device as separate icons.
